(19) United States
(12) Patent Application Publication
(10) Pub. No.: US 2007/0245333 A1
(43) Pub. Date: Oct. 18, 2007

(54) Methods and Systems for Managing Firmware

(76) Inventor: Andrew Rodney Ferlitsch, Tigard, OR (US)

Correspondence Address: KRIEGER INTELLECTUAL PROPERTY, INC., P.O. BOX 1073, CAMAS, WA, 98607, US

(21) Appl. No.: 11/277,551

(22) Filed: Mar. 27, 2006

(51) Int. Cl. G06F 9/44

(52) U.S. Cl. 717/168

(57) ABSTRACT

Embodiments of the present invention comprise systems, methods and devices for managing firmware in a network peripheral device.

### FIELD OF THE INVENTION

Embodiments of the present invention comprise methods and systems for downloading firmware to network peripheral devices.

### BACKGROUND

Updating and changing firmware versions on network peripheral devices can be a cumbersome administrative process. Methods and systems for determining the availability of firmware for devices and for downloading and installing the available firmware in a least burdensome manner for an administrator is desired.

### SUMMARY

In some embodiments of the present invention, a firmware change in a network peripheral device may be affected when a host process communicating with a network peripheral device requests a firmware change on the network peripheral device. The firmware change may be realized by the network peripheral device downloading a version of firmware from a remote site. In alternate embodiments of the present invention, a firmware change in a network peripheral device may be affected when the network peripheral device makes a request for a firmware change to a administrative process that realizes the change by downloading firmware from a remote site.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a diagram of embodiments of the present invention comprising a host process initiation of a firmware update request;

FIG. 2 is a diagram of embodiments of the present invention comprising a network peripheral device accessing firmware updates at a remote site;

FIG. 3 is a diagram of embodiments of the present invention comprising a host process initiating a firmware update request and a network peripheral device accessing firmware updates at a remote site;

FIG. 4 is a diagram of embodiments of the present invention comprising a host process initiation of a firmware change request;

FIG. 5 is a diagram of embodiments of the present invention comprising a secure host downloading a current version of firmware from a remote site;

FIG. 6 is a diagram of embodiments of the present invention comprising a secure host downloading a new version of firmware for a network peripheral device from a remote site;

FIG. 7 is a diagram of embodiments of the present invention comprising a host process initiation of a firmware update request; and

FIG. 8 is a diagram of embodiments of the present invention comprising a host downloading firmware from a remote site.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Embodiments of the present invention comprise methods and systems for changing the firmware on a network peripheral device. A network peripheral device may refer to a printer, a copier, a scanner, a fax, a format converter, a multi-function peripheral, or a document/image server. A network peripheral device may also refer to a television, a digital camera, an electronic whiteboard, a setup box (STB), a telephone, cellphone, or a multi-media device. In general, a network peripheral device refers to any device with the capability of connecting to a network.

Firmware may refer to any piece, portion, or component of device firmware. The network peripheral device and the methods and systems of the present invention may support a decomposition of the device firmware into firmware components, each with its own version number and available updates.

In exemplary embodiments of the present invention, a host communicating with a network peripheral device may initiate a process to upgrade the firmware on the network peripheral device. The upgrade may be realized by downloading a more recent version of firmware than that which currently resides on the network peripheral device, if such a version exists, from a remote site.

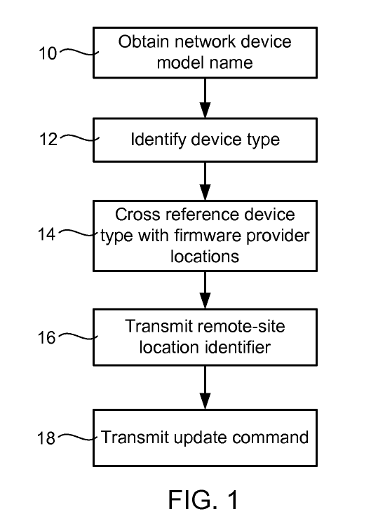

The initiation process at the host is shown in FIG. 1. The host process may obtain 10 the network peripheral device model name from the network peripheral device. The host process may obtain 10 the network peripheral device model name using an SNMP query for the device description OID. The host may obtain the network peripheral device model by other means, such as, UPnP, USB, Bluetooth discovery, etc. The model name may be used by the host process to identify 12 the type of device and cross reference 14 the device type with remote-site locations from which relevant updates may be obtained. The remote-site locations from which relevant updates may be obtained may be contained in a data structure maintained on the host or remote to the host. The contents of the data structure, i.e., the remote-site location identifiers, may be entered manually or obtained through an automated process. The contents of the data structure may also be updated periodically in either a manual or automatic mode. The remote-site location identifiers may be URL addresses, FTP addresses, or other location identifiers.

The host process may then send a message containing the remote-site location identifier 16 and command to perform an update 18 to the network peripheral device. This communication may take the form of a pseudo print job if the network peripheral device is a printing device. For example, the set of PJL commands:

<UEL>
@PJL SET URLUPDATE=http://www.sharpusa.com/modelA/updates.asp
@PJL SET UPDATE=FIRMWARE
<UEL>

may be used to communicate the URL address, http://www.sharpusa.com/modelA/updates.asp, from which updates may be obtained and request the device to update the firmware.

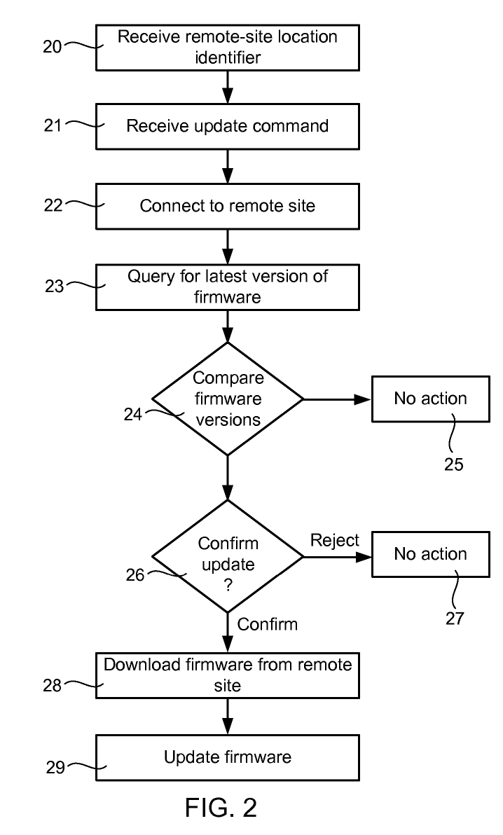

FIG. 2 shows the process at the network peripheral device. The network peripheral device may receive the remote-site location identifier 20 and the command to update the firmware 21. The network peripheral device may then connect to the remote site 22 using the remote-site location identifier. The network peripheral device may then query the host at the remote site for identification of the latest version of firmware available for the device 23. In some embodiments, the URL may be an FTP path where the last component in the path is a location at which files corresponding to updates for the particular model of the network peripheral device reside. The query from the network peripheral device may be, in such embodiments, an FTP command to list all files under the FTP path. In these embodiments, the files correspond to a download, and the version indicator may be incorporated as part of the file name. In some embodiments, the network peripheral device may parse the query results to obtain the identifier for the latest version of firmware available. In other embodiments, the identifier may be communicated directly to the network peripheral device requiring no parsing.

In other embodiments, the URL may be an Active Server Page (ASP); whereby, the content of the ASP page is dynamically created at the time of the request by the network peripheral device to reflect the currently available firmware versions at the time of the request. The available firmware versions may also be dynamically set based on other factors, such as the locality, language culture, and access rights of the network peripheral device.

The network peripheral device may compare 24 the version identifier supplied by the remote site with the version identifier for the firmware currently residing on the network peripheral device. If the firmware currently residing on the network peripheral device is up-to-date, then no action may be required 25. In alternate embodiments, the network peripheral device may communicate to the host process that a more recent version of firmware was not available. If a more recent version of firmware is available from the remote site, then the device may request that the host process confirm the update 26.

The confirmation may comprise an automatic process or an interactive process. If the confirmation is automatic, the new version of firmware is downloaded 28 to the network peripheral device, and the network peripheral device may then install the firmware 29 according to an update mechanism built in the network peripheral device.

In some embodiments, the request to the remote site to download the latest firmware 28 may be an FTP command. In other embodiments, the request to the remote site to download the latest firmware 28 may be an HTTP command.

If the confirmation process is interactive, the network peripheral device may send an update confirmation request to the host process. An exemplary request may be of the form of the following data communication to the host process:

| | |
|---|---|
| DN:<device_name> | #device name |
| CF:<current_version> | #current version in device |
| LF:<latest_version> | #latest version |
| CO:<commentary> | #commentary description from |
| | remote site about the update |
| CU | #confirm update command. |

The host process may then confirm or reject the update request. The host process may display a dialog to an administrator to confirm or reject the update. If the update is rejected, the host process may send a response to the network peripheral device rejecting the update, and the network peripheral device may take no additional action 27. If the update is confirmed, the most recent version of firmware may be downloaded 28 from the remote site to the network peripheral device as in the automatic embodiments, and the network peripheral device may then install the firmware 29 according to an update mechanism built in the network peripheral device.

In other embodiments, the downloaded firmware may be stored on the peripheral device, and the installation may be deferred until some further action or event, such as an administrator physically entering a security code at the network peripheral device.

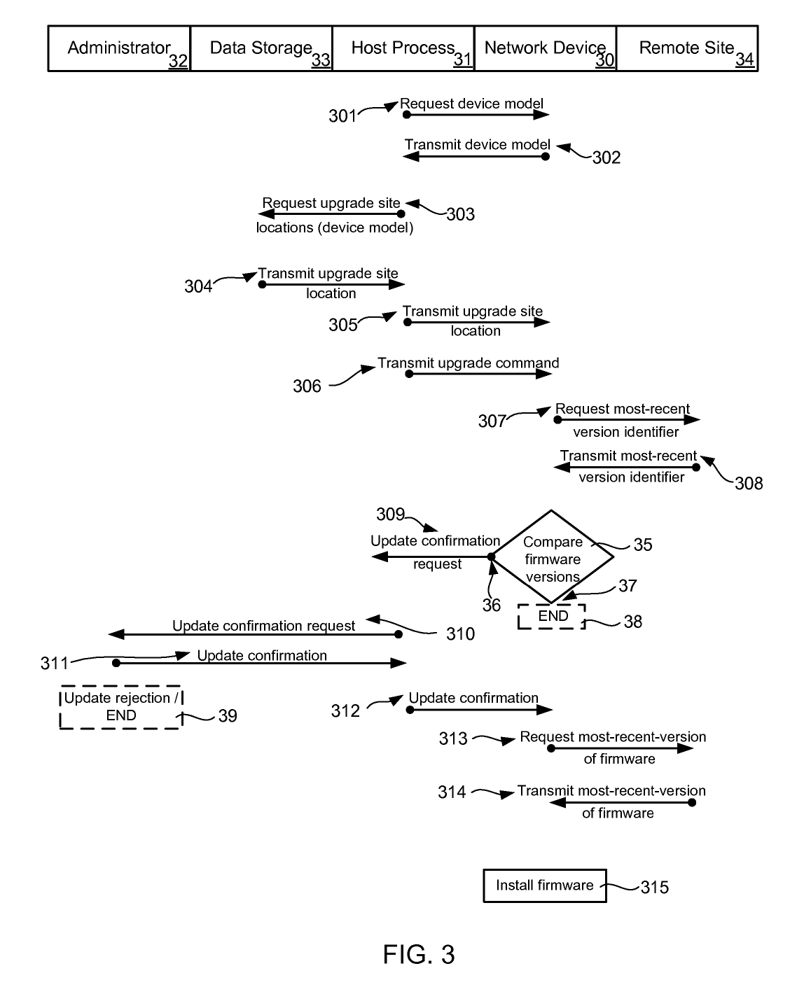

FIG. 3 shows embodiments of the present invention in which the most recent available version of firmware may be installed on a network peripheral device 30. A host process 31 with a user interface to an administrator 32 and access to a data storage unit 33 may request 301 the model identifier of the network peripheral device 30. The network peripheral device 30 may transmit 302 its model identifier to the host process 31. The host process 31 may access 303 the data storage unit 33 to obtain 304 a remote-site location identifier from which firmware for the network peripheral device 30 may be obtained. The host process 31 may transmit 305 the remote-site location identifier to the network peripheral device 30 in addition to transmitting 306 an upgrade command. The network peripheral device 30 may request 307 an identifier for the most recent available version of the firmware from the remote site 34 corresponding to the remote-site location indication. The remote site 34 may transmit to the network peripheral device 30 the identifier for the most recent version of firmware available for download from the remote site 34. The network peripheral device 30 may compare 35 the version identifier for the firmware currently residing on the network peripheral device 30 with the version identifier of the most recent firmware version available from the remote site 34. If a more current firmware version than that currently residing on the network peripheral device 30 is available 36 from the remote site 34, the network peripheral device 30 may request from the host process 31 confirmation to update 309. The host process 31 may transmit an update request 310 to the administrator 32. If the administrator 32 confirms the update request 311, then the host process 31 may confirm the update 312 to the network peripheral device 30. The network peripheral device 30 may request 313 from the remote site 34 the firmware. The remote site 34 may transmit 314 the firmware to the network peripheral device 30, and the network peripheral device 30 may install 315 the firmware according to an installation mechanism built into the network peripheral device 30.

If the comparison 35 yields a result indicating that a firmware version more recent than that which may be provided by the remote site 34 currently resides on the network peripheral device 30, then the upgrade process may terminate 38. The upgrade process may also terminate if the administrator 32 rejects 39 the update confirmation request.

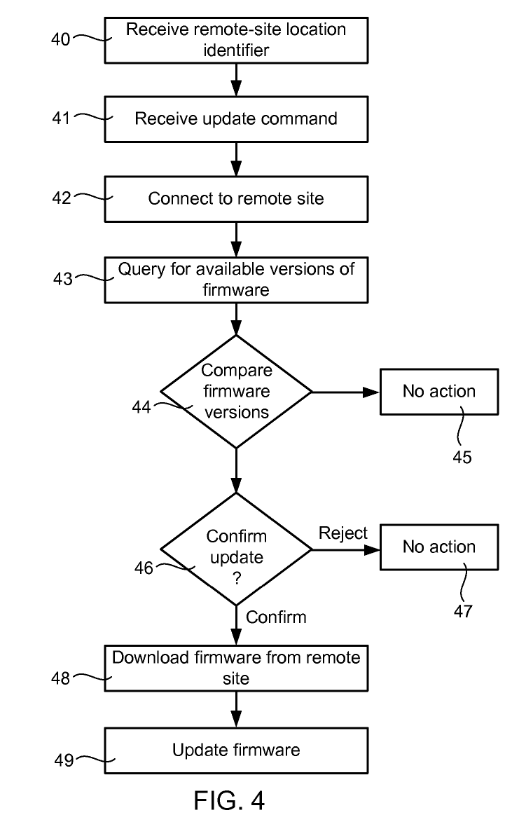

The present invention is not limited to firmware upgrades to a newer version of firmware. In some embodiments of the present invention, the administrative process may initiate a firmware change to a particular version of firmware. The update command may reflect a version of firmware. FIG. 4 illustrates embodiments of the present invention in which the update command contains a target firmware version.

The network peripheral device-may receive the remote-site location identifier 40 and the command to update the firmware 41. The network peripheral device may then connect to the remote site 42 using the remote-site location identifier. The network peripheral device may then query 43 the host at the remote site to identify the versions of the firmware available for the device. In some embodiments, the URL may be an FTP path where the last component in the path is for updates for the particular model of the network peripheral device. The query from the network peripheral device may be, in such embodiments, an FTP command to list all files under the FTP path. In these embodiments, the files correspond to a download, and the version indicator may be incorporated as part of the file name. In some embodiments, the network peripheral device may parse the query results to obtain the identifier for the desired version of firmware and to determine if the version of the firmware is available.

The network peripheral device may compare 44 the version identifiers supplied by the remote site with the version identifier for the target firmware. If the target firmware is not available, then no action may be required 45. In alternate embodiments, the network peripheral device may notify the host process that the target firmware was not available. If the desired version of firmware is available from the remote site, then the device may request that the host process confirm the update 46.

The confirmation may comprise an automatic process or an interactive process. If the confirmation is automatic, the new version of firmware is downloaded 48 to the network peripheral device, and the network peripheral device may then install the firmware 49 according to an update mechanism built in the network peripheral device.

In some embodiments, the request to the remote site to download the latest firmware 48 may be an FTP command. In other embodiments, the request to the remote site to download the latest firmware 48 may be an HTTP command.

If the confirmation process is interactive, the network peripheral device may send a change confirmation request to the host process. An exemplary request may be of the form of the following data communication to the host process:

| | |
|---|---|
| DN:<device_name> | #device name |
| CF:<current_version> | #current version in device |
| DF:<latest_version> | #desired version |
| CO:<commentary> | #commentary description from |
| | remote site about the update |
| CU | #confirm update command. |

The host process may then confirm or reject the update request. The host process may display a dialog to an administrator to confirm or reject the update. If the update is rejected, the host process may send a response to the network peripheral device rejecting the update, and the network peripheral device may take no additional action 47. If the update is confirmed, the most recent version of firmware may be downloaded 48 from the remote site to the network peripheral device as in the automatic embodiments, and the network peripheral device may then install the firmware 49 according to an update mechanism built in the network peripheral device.

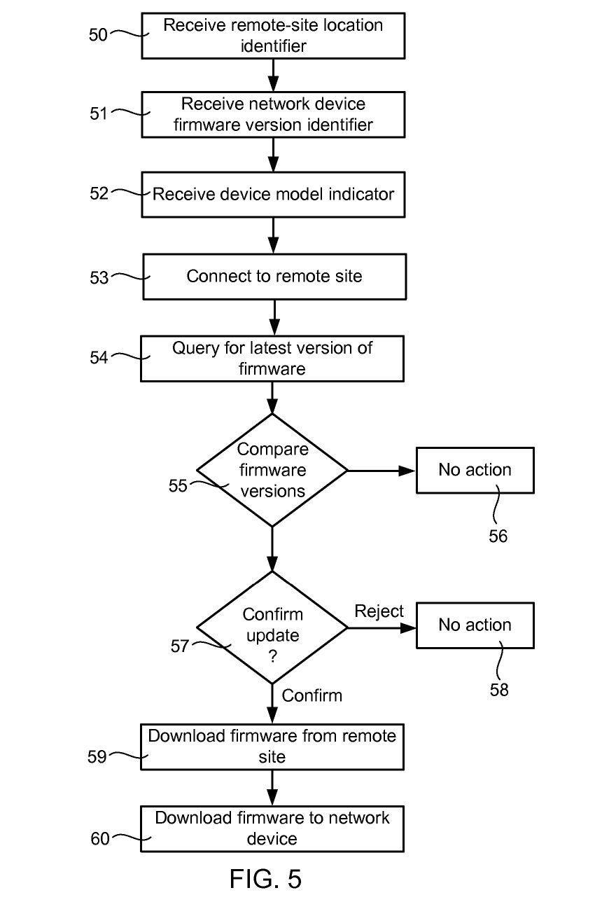

In alternate exemplary embodiments of the present invention shown in FIG. 5, a firmware update process may be initiated at a network peripheral device, and the firmware may be obtained by an administrative process residing on a secured host through a connection to a remote host. The administrative process may receive 50 a remote-site location identifier from the network peripheral device. The remote-site location identifier may be a URL address, an FTP address, or any other location identifier. The administrative process may also receive 51 a firmware version identifier identifying the version of firmware currently residing on the network peripheral device or receive 52 a device model indicator identifying the model of the network peripheral device from the network peripheral device. The administrative process may connect 53 to the remote site identified by the remote-site location identifier. After connecting 53 to the remote site, the administrative process may query 54 the remote site for the latest available version of firmware for a network peripheral device of model corresponding the device model indicator. The administrative process may then compare 55 the firmware version indicator for the firmware residing currently on the network peripheral device and the firmware version indicator for the latest available version of firmware. If the version of firmware residing on the network peripheral device is the latest available version of the firmware, then the administrative process may take no action 56. If the version of firmware available from the remote site is more recent than that currently residing on the network peripheral device, the administrative process may confirm the update 57. The administrative process may confirm the update by sending a message to the network peripheral device.

The network peripheral device may either automatically confirm the update or interactively confirm the update. In embodiments in which the update is confirmed automatically, the network peripheral device may send a message back to the administrative process confirming the update. In embodiments in which the update is confirmed interactively, the network peripheral device may prompt an operator, also considered and administrator, to confirm or reject the update. If the operator rejects the update, the network peripheral device may send the administrative process a message indicating the update was rejected, and no further action 58 may be taken at the network peripheral device. If the operator confirms the update, the network peripheral device may send the administrative process a message confirming the update.

If the update is confirmed, either automatically or interactively, the administrative process may download the firmware update from the remote site 59, and then download the update to the network peripheral device 60. The network peripheral device may install the firmware update according to an update mechanism residing in the network peripheral device.

In other embodiments, the downloaded firmware may be stored on the peripheral device, and the installation may be deferred until some further action or event, such as an administrator physically entering a security code at the network peripheral device.

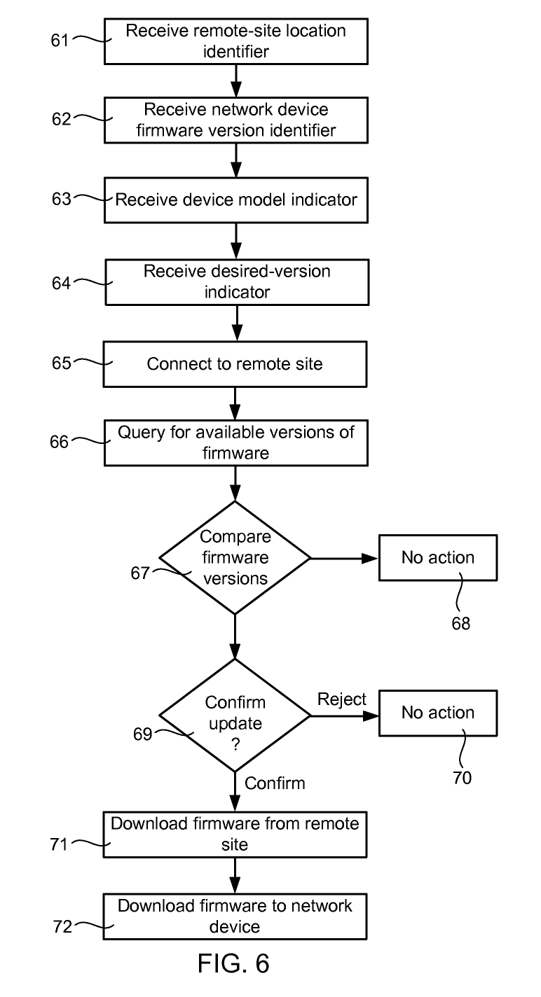

The present invention is not limited to updating the firmware in a network peripheral device to a most recent version of firmware. FIG. 6 shows exemplary embodiments of the present invention in which a firmware change process may be initiated at a network peripheral device, and the firmware may be obtained by an administrative process residing on a secured host through a connection to a remote host.

The administrative process may receive 61 a remote-site location identifier from the network peripheral device. As in exemplary embodiments described above, the remote-site location identifier may be a URL address, an FTP address, or any other location identifier. The administrative process may also receive 62 a firmware version identifier identifying the version of firmware currently residing on the network peripheral device or receive 63 a device model indicator identifying the model of the network peripheral device from the network peripheral device. The administrative process may also receive 64 a desired-version identifier that identifies the version of firmware with which it may be desired to replace the current version of firmware residing on the network peripheral device. The administrative process may connect 65 to the remote site identified by the remote-site location identifier. After connecting 65 to the remote site, the administrative process may query 66 the remote site for the available versions of firmware for a network peripheral device of model corresponding the device model indicator. The administrative process may then compare 67 the firmware version indicator for the desired firmware and the firmware version indicators for the available versions of firmware. If the desired version of firmware is not available, the administrative process may indicate this to the network peripheral device and take no further action 68. If the desired version of firmware is available from the remote site, the administrative process may confirm the update 69. The administrative process may confirm the update by sending a message to the network peripheral device.

The network peripheral device may either automatically confirm the update or interactively confirm the update. In embodiments in which the update is confirmed automatically, the network peripheral device may send a message back to the administrative process confirming the update. In embodiments in which the update is confirmed interactively, the network peripheral device may prompt an operator, also considered and administrator, to confirm or reject the update. If the operator rejects the update, the network peripheral device may send the administrative process a message indicating the update was rejected, and no further action may be taken at the network peripheral device 70. If the operator confirms the update, the network peripheral device may send the administrative process a message confirming the update.

If the update is confirmed, either automatically or interactively, the administrative process may download the firmware update from the remote site 71, and then download the update to the network peripheral device 72. The network peripheral device may install the firmware update according to an update mechanism residing in the network peripheral device.

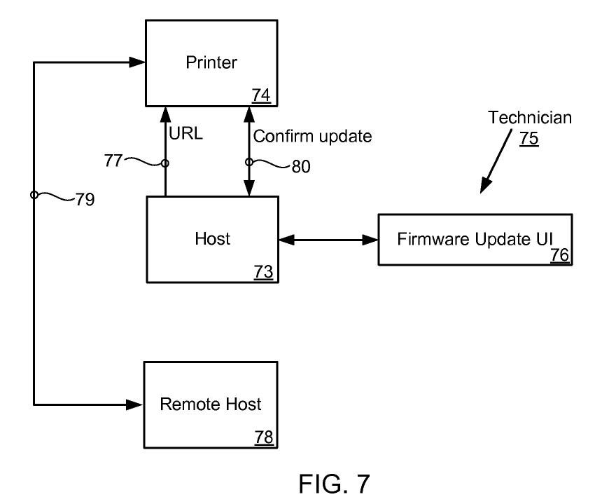

Embodiments of the present invention shown in FIG. 7 comprise an administrative host 73 that may initiate a request to change the firmware on a network printer 74. In some embodiments, the change may comprise a firmware upgrade to a newer version of firmware than currently resides on the printer 74. A network administrator, also considered a technician, may request the upgrade through a user interface 76 in communication with the administrative host 73. The administrative host 73 may be a personal computer or other computing device. The administrative host 73 may transmit a URL 77 to the printer 74. The URL 77 may comprise an address of a remote host 78 from which versions of firmware for the printer 74 may be made available. The printer 74 may connect 79 to the remote host 78 and may query for available firmware. The remote host 78 may communicate information describing the available firmware to the printer 74. The printer 74 may determine if any of the firmware available from the remote host 78 is relevant. If a relevant firmware version is available from the remote host 78, the printer 74 may download the relevant material and may confirm to the administrative host 73 that the download was successfully accomplished. In some embodiments, the printer 74 may request confirmation 80 to upgrade to the relevant firmware version from the administrative host 73. The administrative host 73 may automatically provide confirmation or request confirmation to upgrade from the administrator 75 via the user interface 76. If the upgrade request is confirmed to the printer 74, the printer 74 may download the relevant firmware from the remote host 78 and may perform firmware installation.

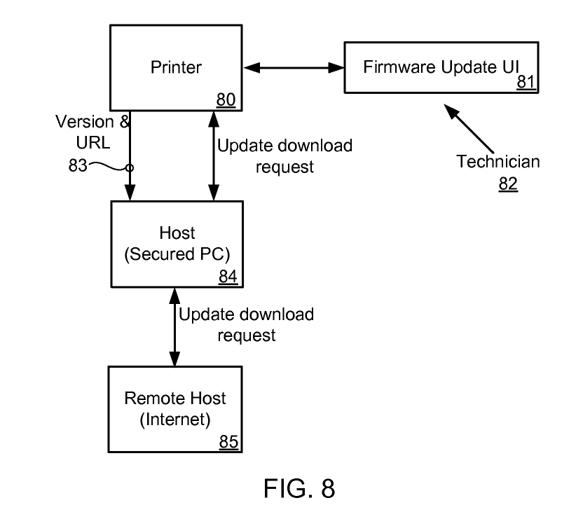

Embodiments of the present invention shown in FIG. 8 comprise a printer 80 with a front panel user interface 81 through which a technician, also considered a system administrator, 82 may request a firmware upgrade or change. Upon receiving a request from the front panel 81, the printer 80 may transmit 83 a firmware version and URL to a host 84. In some embodiments, the host 84 is a secure host. In some embodiments, the host 84 is a computing device or a secure computing device. The host 84 may connect to a remote host 85 identified by the URL and may query for the availability of relevant firmware versions. The remote host 85 may communicate the availability of a relevant firmware version to the host 84. The host 84 may then download the relevant firmware and may transmit the firmware to the printer 80. The printer 80 may then install the firmware and may send a confirmation to the front panel 81. In some embodiments, the host 84 may request confirmation from the printer 80 prior to downloading the relevant firmware. The printer may automatically generate a confirmation or request a confirmation from the technician 82 via the front panel 81. Upon receiving the confirmation, the host 84 may download the relevant firmware from the remote host 85, and subsequently may transmit the firmware to the printer 80. The printer 80 may perform firmware installation of the relevant firmware.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

I claim:

1. A method for downloading firmware for a network peripheral device, said method comprising:
a) receiving a remote-site location identifier at a network peripheral device;
b) receiving an update command at said network peripheral device;
c) obtaining a first firmware-version identifier, at said network peripheral device, from a remote host identified by said remote-site location identifier;
d) obtaining a second firmware-version identifier at said network peripheral device;
e) comparing said first firmware-version identifier with said second firmware-version identifier at said network peripheral device thereby producing a firmware comparison result; and
f) downloading said firmware at said network peripheral device based on said firmware comparison result.

2. The method of claim 1 wherein said downloading occurs when said firmware comparison result indicates whether or not said first version of said firmware is more recent than said second version of said firmware.

3. The method of claim 1 wherein said remote-site location identifier comprises a URL.

4. The method of claim 1 wherein said remote-site location identifier comprises an FTP path.

5. The method of claim 1 wherein said second firmware-version identifier comprises the version of said firmware residing on said network peripheral device.

6. The method of claim 1 wherein said network peripheral device is an imaging device.

7. A system for downloading firmware for a network peripheral device, said system comprising:
a) a receiver for receiving a remote-site location identifier at a network peripheral device;
b) a receiver for receiving an update command at said network peripheral device;
c) an obtainer for obtaining a first firmware-version identifier, at said network peripheral device, from a remote host identified by said remote-site location identifier;
d) an obtainer obtaining a second firmware-version identifier at said network peripheral device;
e) a comparator for comparing said first firmware-version identifier with said second firmware-version identifier at said network peripheral device thereby producing a firmware comparison result; and
f) a downloader for downloading said firmware at said network peripheral device based on said firmware comparison result.

8. The system of claim 7 wherein said downloading occurs when said firmware comparison result indicates whether or not said first version of said firmware is more recent than said second version of said firmware.

9. The system of claim 7 wherein said remote-site location identifier comprises a URL.

10. The system of claim 7 wherein said remote-site location identifier comprises an FTP path.

11. The system of claim 7 wherein said second firmware-version identifier comprises the version of said firmware residing on said network peripheral device.

12. The system of claim 7 wherein said network peripheral device is an imaging device.

13. A method for updating firmware on a network peripheral device, said method comprising:
a) receiving a remote-site location identifier from a network peripheral device;
b) receiving a first firmware-version identifier from said network peripheral device;
c) receiving a model identifier for said network peripheral device from said network peripheral device;
d) obtaining a second firmware-version identifier from a remote host identified by said remote-site location identifier;
e) comparing said first firmware-version identifier with said second firmware-version identifier thereby producing a firmware comparison result;
f) downloading said firmware based on said firmware comparison result; and
g) transferring said firmware to said network peripheral device.

14. The method of claim 13 wherein said downloading occurs when said firmware comparison result indicates whether or not said second version of said firmware is more recent than said first version of said firmware.

15. The method of claim 13 wherein said remote-site location identifier comprises a URL.

16. The method of claim 13 wherein said remote-site location identifier comprises an FTP path.

17. The method of claim 13 wherein said first firmware-version identifier comprises the version of said firmware residing on said network peripheral device.

18. The method of claim 13 wherein said network peripheral device is an imaging device.

19. A system for updating firmware on a network peripheral device, said system comprising:
a) a receiver for receiving a remote-site location identifier from a network peripheral device;
b) a receiver for receiving a first firmware-version identifier from said network peripheral device;
c) a receiver for receiving a model number for said network peripheral device from said network peripheral device;
d) an obtainer for obtaining a second firmware-version identifier from a remote host identified by said remote-site location identifier;
e) a comparator for comparing said first firmware-version identifier with said second firmware-version identifier thereby producing a firmware comparison result;
f) a downloader for downloading said firmware based on said firmware comparison result; and
g) a transmitter for transferring said firmware to said network peripheral device.

20. The system of claim 19 wherein said downloading occurs when said firmware comparison result indicates whether or note said second version of said firmware is more recent than first version of said firmware.

21. The system of claim 19 wherein said remote-site location identifier comprises a URL.

22. The system of claim 19 wherein said remote-site location identifier comprises an FTP path.

23. The system of claim 19 wherein said first firmware-version identifier comprises the version of said firmware residing on said network peripheral device.

24. The system of claim 19 wherein said network peripheral device is an imaging device.
